(19) United States
(12) Patent Application Publication
(10) Pub. No.: US 2026/0222084 A1
(43) Pub. Date: Jul. 30, 2026

(54) RESONANT FREQUENCY COMMUNICATIONS IN AN ENCLOSED VOLUME

(71) Applicant: UNIVERSITY COLLEGE CORK - NATIONAL UNIVERSITY OF IRELAND, CORK, Cork (IE)

(72) Inventors: Senad BULJA, Dublin (IE); Holger CLAUSSEN, Carton Demesne, Maynooth (IE)

(21) Appl. No.: 19/141,290

(22) PCT Filed: Dec. 21, 2023
(86) PCT No.: PCT/EP2023/087437

§ 371 Date: Jun. 19, 2025

(30) Foreign Application Priority Data
Dec. 23, 2022 (GB) 2219712.3

(51) Int. Cl. H04B 13/00; H01Q 9/16

(52) U.S. Cl. CPC H04B 13/005; H01Q 9/16

(57) ABSTRACT

Disclosed is a method for enabling communications within an enclosed volume. The method includes providing a plurality of nodes within the enclosed volume that communicate at one or more eigenmode resonant frequencies of the enclosed volume, wherein the enclosed volume is a resonator, and wherein one or more optimum frequencies of communication among the plurality of nodes is selected from the eigenmode resonant frequencies.

### PRIORITY CLAIM

This application is the U.S. National Stage of International Patent Application No. PCT/EP2023/0087437 filed 21 Dec. 2023, which claims priority to United Kingdom Patent Application No. GB 2219712.3 filed 23 Dec. 2022, the entire content of these applications being incorporated herein by reference as if fully set forth below in their entirety and for all applicable purposes.

### TECHNICAL FIELD

The present disclosure relates to communications among a number of transceivers inside an enclosed volume, and more specifically to communication among transceivers equipped with sensors and/or actuators inside an enclosed volume.

### BACKGROUND

Communications in an enclosed volume in a propagation-wise challenging environment (high losses) is difficult with standard Radio Frequency (RF) communication. Here, every sensor equipped with a transmitter will have a standard RF antenna and communications among the sensors are conducted in its far-field regions. Due to the limited size of the enclosed space and the fact that the standard RF antenna has its length commensurate with the wavelength of operation, i.e. typically half-wavelength, this approach requires the frequencies of operation to be high enough so that the standard propagation models can be applied. This results in very high propagation losses, for the case when the enclosed volume is filled with lossy material.

Another approach is acoustic communication, in that the communications among the sensors are conducted at acoustic frequencies, which are much lower than the frequencies outlined in the standard RF approach. The main problem with this approach lies with the fact that acoustics are easily affected by varying environment conditions inside the vessel, such as changes in temperature, noise and inhomogeneous medium.

Yet another approach is optical communication, which is limited to line-of-sight and is easily affected by obstacles placed in the communications path.

### SUMMARY

According to the invention there is provided, as set out in the appended claims, a method for enabling communications within an enclosed volume. The method includes providing a plurality of nodes within the enclosed volume that communicate at one or more eigenmode resonant frequencies of the enclosed volume, wherein the enclosed volume is a resonator, and wherein one or more optimum frequencies of communication among the plurality of nodes is selected from the eigenmode resonant frequencies.

In an embodiment of the present invention, the enclosed volume is one of: a mixing vessel and an implant.

In an embodiment of the present invention, the enclosed volume is filled with a dielectric material.

In an embodiment of the present invention, each node is a sensor and/or actuator.

In an embodiment of the present invention, the node contains a standard short dipole.

In an embodiment of the present invention, the selection of the one or more optimum frequencies of communication comprises: sending a request from a transmit node to each receiver node, wherein the request includes a number of known data packets at pre-selected frequencies; receiving response from each receiver node, wherein the response includes information regarding receipt of the data packets, and information on the frequencies of the received data packets and the amount of insertion loss incurred; and choosing a frequency and a receiver corresponding to a highest received power or lowest propagation loss for further communications.

In an embodiment of the present invention, a successful ping and reply handshake identifies a neighboring communication node which gets added to a network list along with corresponding frequency.

In an embodiment of the present invention, when a receiving node does not reply to the request of the transmit node, the transmit node decides to task one of the remaining receiving nodes to interrogate a non-responsive node and act as an intermediate node during future communications.

In an embodiment of the present invention, each node has its own ID and its messages can be distinguished from others when nodes operate on the same frequency.

In an embodiment of the present invention, the nodes on the network list share corresponding best frequencies and a single node calculates a best joint frequency and transmits to other nodes.

In an embodiment of the present invention, the method further includes performing a frequency auto-configuration approach by the plurality of nodes within the enclosed volume to discover on which frequencies corresponding neighboring nodes can communicate.

In an embodiment of the present invention, the method further includes optionally switching between listening and sending modes to discover additional neighbor communication links.

In accordance with another aspect of the present invention, there is provided a system for enabling communications within an enclosed volume. The system includes a plurality of nodes within the enclosed volume that communicate at one or more eigenmode resonant frequencies of the enclosed volume, wherein the enclosed volume is a resonator, and wherein one or more optimum frequencies of communication among the plurality of nodes is selected from the eigenmode resonant frequencies.

Various embodiments of the present invention facilitate communications inside enclosed volumes using RF means and aim to take the advantage of the fact that an enclosed volume can be treated as a resonator, rather than a standard RF transmission medium. It is well known from the theory of resonators that the loss in energy transmission is minimized at resonance. This is due to the fact that the only losses at resonance are due to joule losses, rather than a combination of joule and reactive losses of the medium present at non-resonant frequencies. Therefore, the communications inside an enclosed space may be conducted at eigenmode resonant frequencies of the vessel to provide low loss RF communications. As compared to the traditional solution, in one example, the proposed concept reduces the antenna size from 1 m to 20 cm, while improving signal strength over 1000 times. For in-body communications, the size of the antennas may be much smaller.

Various advantages of the present invention include lower insertion losses and no need for a traditional antenna (much smaller size). By using such an approach to communications within an enclosed volume rather than conventional RF communication techniques, it results in a reduction in antenna size and an improvement in signal strength. Further, as compared to acoustic solutions, the present system is not easily affected by changes in temperature and noise. Furthermore, as compared to optical solution, the present invention is not limited by line of sight and obstacles. In particular, the solution circumvents the standard RF problems associated with communication inside an enclosed space, such as high losses and the need for an antenna.

There is also provided a computer program comprising program instructions for causing a computer program to carry out the above method which may be embodied on a record medium, carrier signal or read-only memory.

### BRIEF DESCRIPTION OF THE DRAWINGS

The invention will be more clearly understood from the following description of an embodiment thereof, given by way of example only, with reference to the accompanying drawings, in which: —

FIG. 1A illustrates an exemplary enclosed volume filled with a dielectric material;

FIG. 1B illustrates the distribution of the electric field of the fundamental resonant mode of said resonator at a resonant frequency;

FIG. 2A illustrates first and second sensors placed far apart from each other inside the cavity of the vessel;

FIG. 2B illustrates a first plot of transmission coefficient (S₂₁) between the first and second sensors;

FIG. 3 illustrates the distribution of the electric field of 373^{rd} mode in the vessel at a frequency of 16.75 MHz;

FIG. 4 illustrates a grainfather vessel that can be filled with water, Carbapol mixture and Carbapol gel for conducting measurements;

FIG. 5 illustrates an exemplary sub-wavelength size probe;

FIG. 6A illustrates an exemplary scenario with four nodes in a vessel, in accordance with an embodiment of the present invention;

FIG. 6B illustrates an example scenario with five nodes in a vessel, where first node is connected indirectly via fourth node to first node, in accordance with an embodiment of the present invention;

FIG. 7 illustrates responses of dipoles of various sizes in the air;

FIG. 8 illustrates measured transmission responses of dipoles of various sizes in water;

FIG. 9 illustrates various transmission measurements for three types of transmitter-receiver arrangements respectively, in water inside the vessel, in accordance with an embodiment of the present invention;

FIGS. 10A and 10B illustrate various transmission measurements conducted for three types of transmitter-receiver arrangements respectively, in Carbapol mix inside the vessel, in accordance with an embodiment of the present invention;

FIGS. 11A and 11B illustrate various transmission measurements conducted for three types of transmitter-receiver arrangements respectively, in Carbapol gel mix inside the vessel, in accordance with an embodiment of the present invention; and

FIGS. 12A and 12B illustrate measured transmission responses of first, second and third dipole arrangements in first, second and third environments respectively.

### DETAILED DESCRIPTION

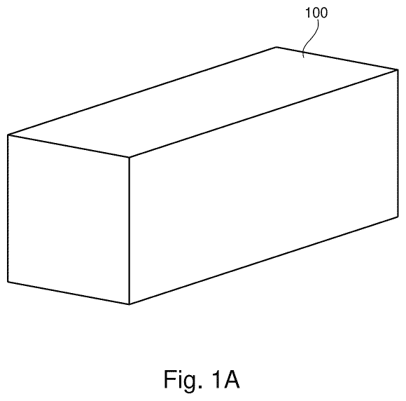

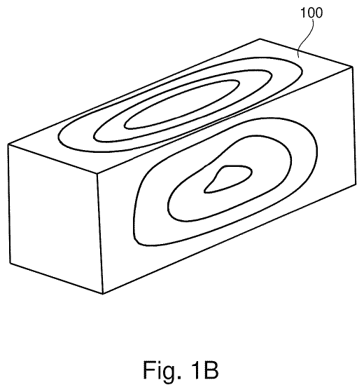

FIG. 1A illustrates an exemplary enclosed volume 100 of dimensions of 5 m×5 m×15 m which is filled with a dielectric material having a relative dielectric permittivity of εᵣ=80 and tan(δ)=0.05. Examples of the enclosed volume 100 include a mixing vessel, or a human body for facilitating in-body communications with implants or medical devices. In the preferred embodiment, the enclosed volume 100 is a vessel 100 that may act as a resonator. Any resonator has an infinite number of natural, eigenmode frequencies, where each resonant frequency has a well-defined Electro-Magnetic (EM) distribution, with corresponding maxima and minima. An exception to this are the so-called degenerate modes, which have a different distribution of EM fields, while operating at identical frequencies.

From the classical theory of resonators, it is known that lowest transmission loss occurs at resonant frequencies, since the losses in that case are purely dominated by ohmic (joule) losses of the medium. The reactive losses at resonant frequencies are equal to zero. Depending on the resonator type, its external excitation is performed using a short (sub-wavelength) probe that is either shorted to the ground (magnetic coupling) or left open-ended (electric coupling). In other words, a resonator is not excited using an antenna in a classical sense. The present approach lies with treating the vessel (enclosed cavity) as a resonator that is filled with a dielectric material, with transceivers (TRX) placed inside it.

FIG. 1B illustrates the distribution of the electric field of the fundamental resonant mode of said resonator at a resonant frequency of 3.73 MHz, and with an unloaded Quality (Q) factor of approximately 100. For the purpose of the Q factor calculations, it is assumed that the cavity is grounded and that the conductivity of the enclosure is 4×10⁷ S/m. It is to be noted that choosing a lower value of the conductivity would, inevitably, reduce the value of the Q factor, as commonly known. As can be seen, the electric field distribution is strongest in the middle, while it is very low at the extremities of the enclosed volume 100. This infers that the proposed resonator 100 can be easily excited at the fundamental frequency by placing a probe at its center, while it would be almost impossible to excite it by placing a probe at its peripheries. If now two nodes (transceivers) are placed near the center of the cavity and made to excite the fundamental mode efficiently, the communication loss between the two nodes would be very low. However, lower communication losses between two arbitrary nodes may be also possible at higher order modes.

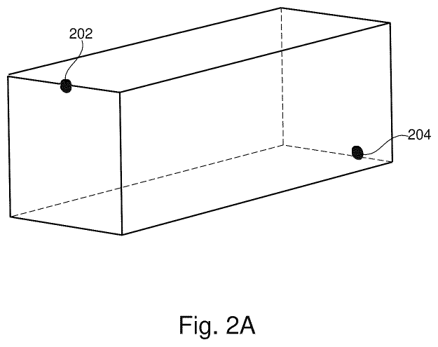

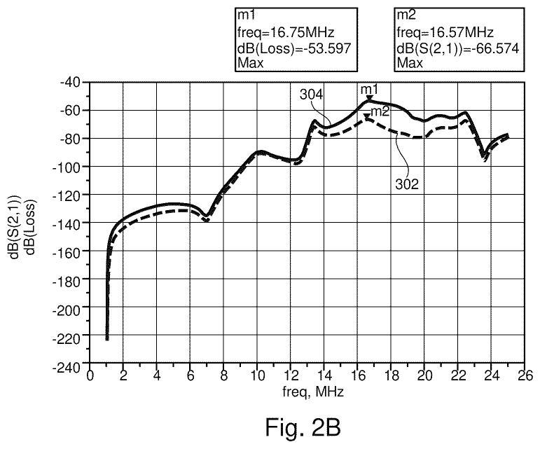

FIG. 2A illustrates first and second nodes 202 and 204 placed far apart from each other inside the cavity of the vessel 100. The nodes 202 and 204 are approximately 20 cm in length (corresponding to λ_{g}/100 at resonant frequency) and are separated from each other (edge-to-edge) by a distance of 12.85 m. Examples of the nodes 202 and 204 include transceivers, and they are of the form of a standard short dipole. However, this may not be the optimum excitation mode—it is entirely used for demonstration purposes. Nevertheless, its length is extremely short for the given frequency of operation.

FIG. 2B illustrates a first plot 302 of transmission coefficient (Sai) between the first and second nodes 202 and 204. However, since the transmission coefficient does not capture the exact value of the return losses, it is modified to obtain a second plot 304 so that the return losses are inherently included and perfect impedance matched conditions are obtained. FIG. 2B indicates that the optimum transmission frequency between these two nodes is around 16 MHz and that the insertion losses are kept at 53 dB, which, for the given size of the “antenna”, is an extremely good result.

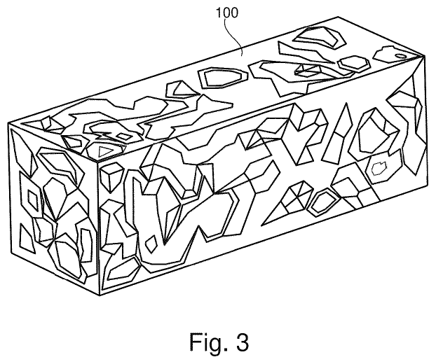

FIG. 3 illustrates the distribution of the electric field of 373^{rd} mode in the vessel 100 at a frequency of 16.75 MHz. For the purpose of the comparison, the total insertion loss between these two nodes for the case of no vessel boundary would be around 84 dB. The size of the antennas in this case would be around 1 m.

There may be a scenario, when there are more than two nodes in the cavity and the optimum communication frequencies among them are not identical. This case can occur, since the nodes can be arbitrarily placed inside the cavity. First, the transmission loss between any two nodes is measured during the communication initiation stage. This can be done by having one node sending a number of known data packets at pre-selected frequencies to all other nodes. The receiving nodes reply to this request by informing the transmit node of the receipt of the data packets. The receipt can contain the information on the frequencies of the received data packets and the amount of insertion loss incurred. Based on the received information, the transmit node would choose the frequency of the lowest propagation loss for future communications. A successful ping and reply handshake identifies a neighboring communication node which gets added to a network list (including its listening frequency). If, for example, some receiving nodes do not reply to this request of the transmit node (inferring that the signal did not reach them), the transmit node may decide to task one of the remaining receiving nodes to interrogate the non-responsive node and, if needed, act as an intermediate node during future communications. Each node may have its own ID and its messages can be distinguished when nodes operate on the same frequency.

Refinement step: all nodes on the network list share their best frequencies and one node calculates the best joint frequency and transmits it to others. Subsequently all nodes switch to use the common communication frequency. In communication mode, multi-node communication is performed using Carrier Sense Multiple Access (CSMA) protocol to avoid collisions when multiple nodes use the same frequency.

The proposed concept can be further extended to communications outside the vessel by having a non-conductive opening in the vessel enabling leakage of RF power to the outside world. In a similar vein, the concept can be applied to body communications, where communications with the outside world can be performed by using a bodily mounted antenna.

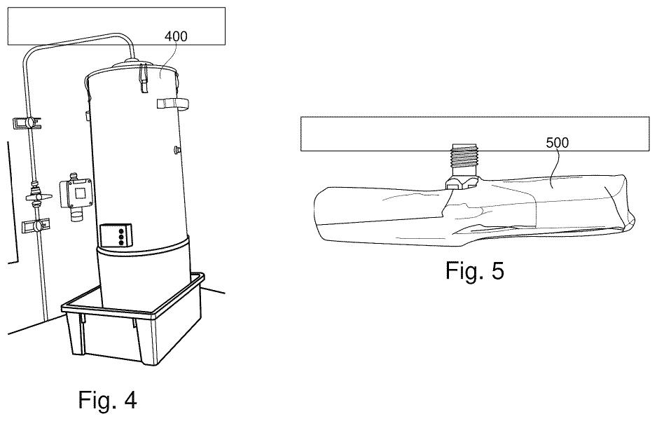

FIG. 4 illustrates a grainfather vessel 400 that can be filled with water, Carbapol mixture and Carbapol gel for conducting measurements. In an example, the size of the vessel is 0.5 m diameter and a height of 1 m. FIG. 5 illustrates an exemplary sub-wavelength size probe 500 of length 6 cm, used to excite the cavity formed by the vessel 400. The probe 500 may be hereinafter also referred to as dipole. Here, the size of the probes used to excite the vessel may have the lengths of 6 cm, 10 cm and 14 cm.

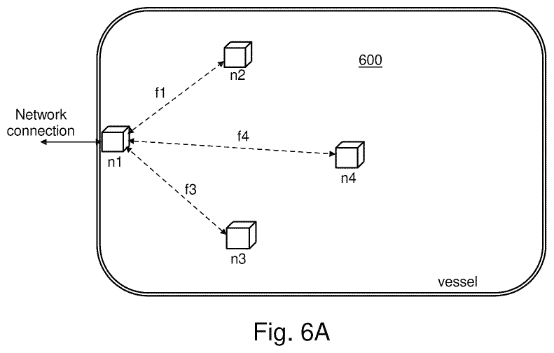

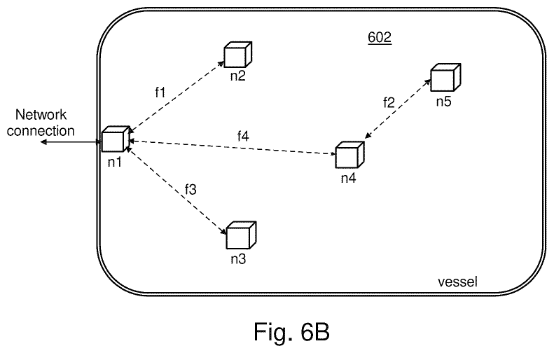

FIG. 6A illustrates an exemplary scenario with four nodes n1, n2, n3, n4 in a vessel 600, in accordance with an embodiment of the present invention. FIG. 6B illustrates an example scenario with 5 nodes n1, n2, n3, n4, n5 in a vessel 602, where n5 is connected indirectly via n4 to n1.

In an embodiment of the present invention, a frequency auto-configuration approach is performed by the nodes in the vessel to discover on which frequencies neighboring nodes can communicate. This can be captured in a neighbor relationship table, as illustrated in Table 1 for the scenario shown in FIG. 6A. Each node has a unique node ID from (in this example) from 1 . . . 4. This ID can be pre-configured or allocated during the auto-configuration process.

TABLE 1
Example neighbor relationship table for Node 1

| Node | f1 | f2 | f3 | f4 | f5 | . . . | fn |
|---|---|---|---|---|---|---|---|
| 1 <-> 2 | −50 dBm | −73 dBm | −62 dBm | −93 dBm | −81 dBm | | −61 dBm |
| 1 <-> 3 | −97 dBm | −54 dBm | −43 dBm | −89 dBm | −65 dBm | | −77 dBm |
| 1 <-> 4 | −96 dBm | −75 dBm | −83 dBm | −55 dBm | −63 dBm | | −89 dBm |

In one example, the neighbor relation tables can be configured as follows:

The first connected node is in listening mode, listening on all frequencies (either simultaneously, or iteratively). All un-connected nodes are in transmit mode, and repeatedly try sending a paging message, cycling through all different frequencies. This paging message contains the node ID and transmit power.

When the first connected node received a paging message, it can store the received power (alternatively, path-loss or other signal quality metric) in the neighbor relationship table, and reply with a message on the same frequency, so that the un-connected node can update its neighbor relationship table.

For communication with a neighboring node, the frequency with the highest received power (alternatively, lowest path-loss or best other signal quality metric) is selected.

If only connected nodes reply, the unconnected nodes know the direction that messages (e.g. data measurements in case of sensor nodes) should be sent (to the replying node). Each unconnected node stores this information, and then becomes a connected node, switching to listening mode. For larger networks where not all nodes can hear each other, nodes can exchange their neighboring tables to allow global visibility of all connections to allow for routing between all nodes. This is illustrated in Table 2 and FIG. 6B.

TABLE 2
Example extended neighbor relationship table

| Node | f1 | f2 | f3 | f4 | f5 | . . . | Fn |
|---|---|---|---|---|---|---|---|
| 1 <-> 2 | −50 dBm | −73 dBm | −62 dBm | −93 dBm | −81 dBm | | −61 dBm |
| 1 <-> 3 | −97 dBm | −54 dBm | −43 dBm | −89 dBm | −65 dBm | | −77 dBm |
| 1 <-> 4 | −96 dBm | −75 dBm | −83 dBm | −55 dBm | −63 dBm | | −89 dBm |
| 4 <-> 5 | −88 dBm | −41 dBm | −64 dBm | −68 dBm | −73 dBm | | −97 dBm |

Optionally connected nodes can switch between listening and sending mode to discover additional neighbor communication links, that may be useful for increased robustness (e.g. mesh network). In case where nodes are not statically deployed, the neighbor relationship needs to be updated regularly to ensure connectivity.

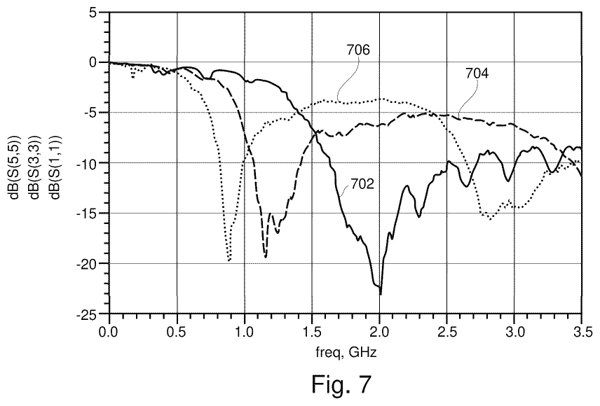

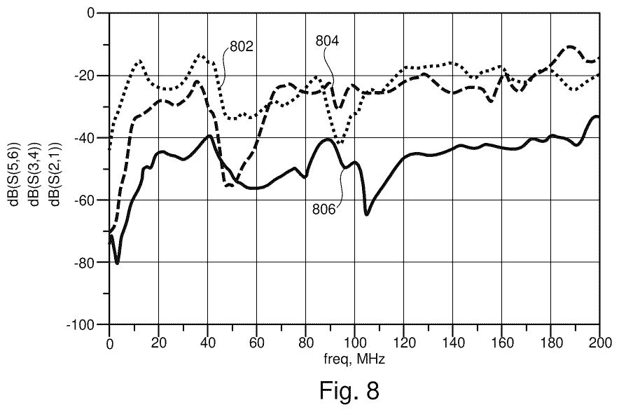

FIG. 7 illustrates reflection coefficient responses 702, 704 and 706 of first, second and third dipoles of sizes 6, 10 and 14 cm respectively, when they are initially tested for their operation in the air. Based on the figure, it follows that the dipoles do not act as antennas at low frequencies (MHz range), rather, their response shows that the dipoles operate as antennas at frequencies of 2 GHz (6 cm dipole), 1.15 GHz (10 cm dipole) and 0.9 GHz (14 cm dipole). FIG. 8 illustrates measured transmission responses 802, 804 and 806 of first, second and third dipoles of sizes 6, 10 and 14 cm in water respectively.

For the measurements inside the vessel 500, two dipoles are used: one dipole is placed at the bottom of the vessel 500, and another dipole is placed near the top of the full vessel 500, and various measurements are conducted in water, Carbapol mix and Carbapol gel for various dipole arrangements to obtain various values of transmission coefficients.

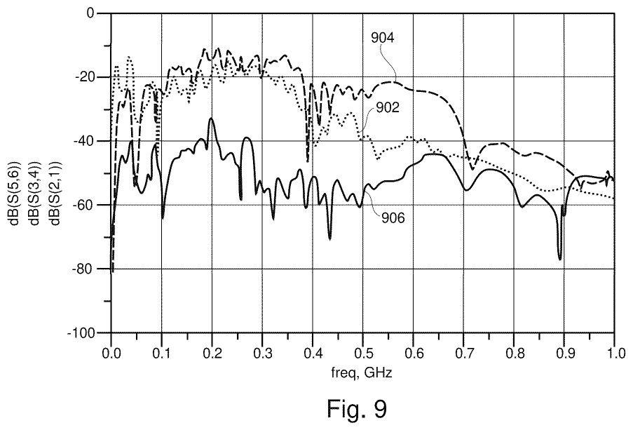

FIG. 9 illustrates various transmission measurements 902, 904 and 906 conducted for three types of transmitter-receiver arrangements respectively, in water inside the vessel 500, in accordance with an embodiment of the present invention. The transmission measurement 902 corresponds to a first dipole arrangement including a TX (6 cm) and RX (10 cm). The transmission measurement 904 corresponds to a second dipole arrangement including a TX (6 cm) and RX (14 cm). The transmission measurement 906 corresponds to a third dipole arrangement including a TX (10 cm) and RX (14 cm). It follows from these measurements that the first dipole arrangement yields best results and the optimum transmission frequencies in this case are 11 MHz and 36 MHz.

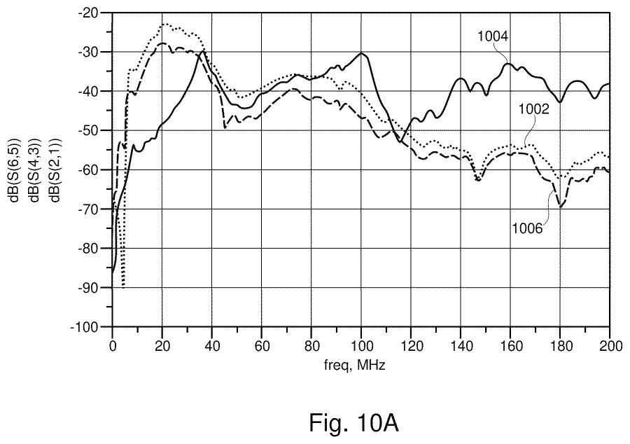

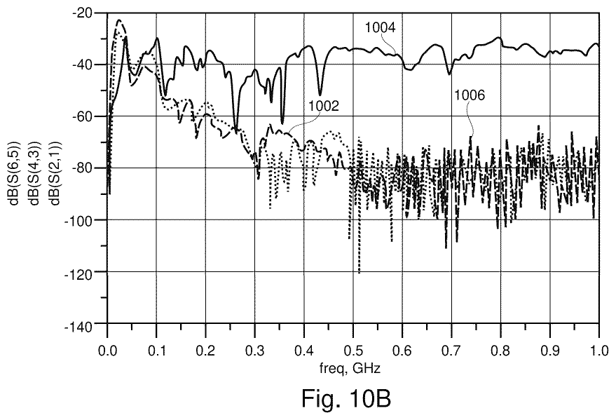

FIGS. 10A and 10B illustrate various transmission measurements 1002, 1004 and 1006 conducted for three types of transmitter-receiver arrangements respectively, in Carbapol mix inside the vessel 500, in accordance with an embodiment of the present invention. The transmission measurement 1002 corresponds to a first dipole arrangement including a TX (10 cm) and RX (6 cm). The transmission measurement 1004 corresponds to a second dipole arrangement including a TX (10 cm) and RX (14 cm). The transmission measurement 1006 corresponds to a third dipole arrangement including a TX (14 cm) and RX (6 cm). It follows from these measurements that the second dipole arrangement yields best results, however, this configuration is, in terms of size, largest. If size is factored in, the first dipole arrangement is optimum, yielding an insertion loss of about 40 dB at a frequency of 39 MHz.

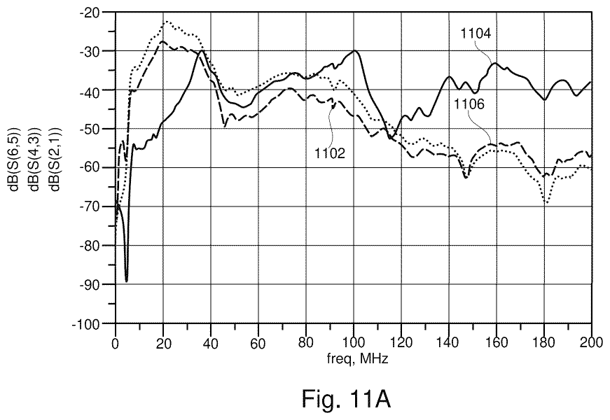

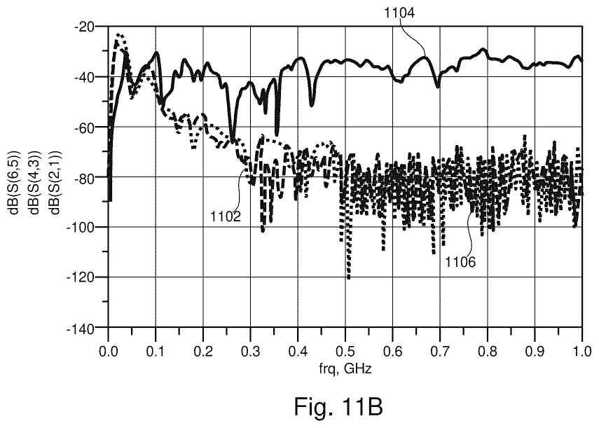

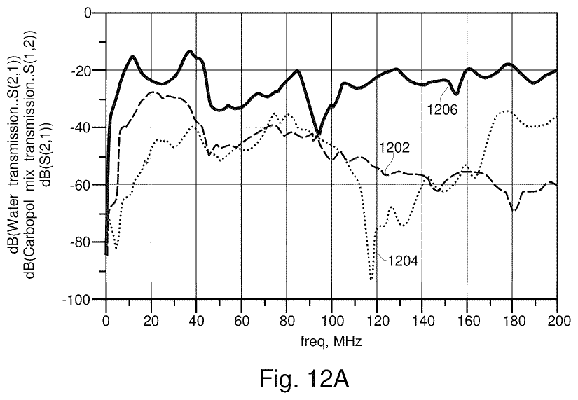

FIGS. 11A and 11B illustrate various transmission measurements 1102, 1104 and 1106 conducted for three types of transmitter-receiver arrangements respectively, in Carbapol gel mix inside the vessel 500, in accordance with an embodiment of the present invention. The transmission measurement 1102 corresponds to a first dipole arrangement including a TX (6 cm) and RX (10 cm). The transmission measurement 1104 corresponds to a second dipole arrangement including a TX (10 cm) and RX (14 cm). The transmission measurement 1106 corresponds to a third dipole arrangement including a TX (10 cm) and RX (14 cm). It follows from these measurements that the second dipole arrangement yields best results, however, even though it is not the largest configuration, its size is greater than the first dipole arrangement. If size is factored in, the first dipole configuration is optimum, yielding an insertion loss of about 28 dB at a frequency of 20 MHz.

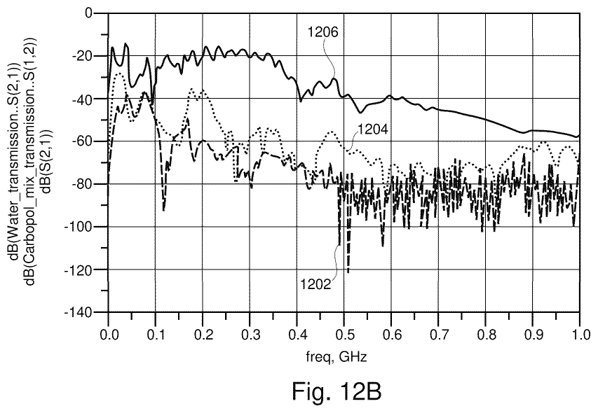

FIGS. 12A and 12B illustrate measured transmission responses 1202, 1204 and 1206 of first, second and third dipole arrangements in first, second and third environments respectively. It will be now instructive to compare the performance of short dipoles in the smallest configuration (6 cm-10 cm) in different environments (water, Carbapol mix and Carbapol gel). The transmission response 1202 corresponds to Carbapol gel, the transmission response 1204 corresponds to Carbapol mix, and the transmission response 1206 corresponds to water. It is to be noted that the lowest losses recorded for water are at 15 dB at a frequency of 11.4 MHz. The Carbapol mix has high attenuation at lower frequencies, while Carbapol gel has a moderate insertion loss of about 27 dB at a frequency of 20 MHz. Thus, depending on the particular arrangement and depending on the type of liquid measured, it is always possible to find the optimum transmission frequency. In the case of Carbapol mix, the optimum transmission frequency is 75 MHz at which the losses are about 35 dB. It is important to realize that at this particular frequency, all other media have similar levels of loss.

It has been shown that non-standard (in-vessel, over-moded) RF communications are possible in lossy liquids. The results also show that the size of dipoles can be even further reduced, given the fact that standard transceivers operating at MHz frequencies have a rather high sensitivity. An example: a transceiver operating at several MHz, would have the sensitivity of −70 to −80 dBm, while the radiated power used by the dipoles would be around 30 dBm. This infers that there is a link budget of about 100 dBm.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. a memory stick or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

What is claimed is:

1. A method for enabling communications within an enclosed volume, comprising:
providing a plurality of nodes within the enclosed volume that communicate at one or more eigenmode resonant frequencies of the enclosed volume,
wherein the enclosed volume is a resonator, and wherein one or more optimum frequencies of communication among the plurality of nodes is selected from the eigenmode resonant frequencies.

2. The method of claim 1, wherein the enclosed volume is one of: a mixing vessel and an implant.

3. The method of claim 1, wherein the enclosed volume is filled with a dielectric material.

4. The method of claim 1, wherein each node includes a sensor and/or an actuator.

5. The method of claim 1, wherein the node contains a standard short dipole.

6. The method of claim 1, wherein the selection of the one or more optimum frequencies of communication comprises:
sending a request from a transmit node to each receiver node, wherein the request includes a number of known data packets at pre-selected frequencies;
receiving response from each receiver node, wherein the response includes information regarding receipt of the data packets, and information on the frequencies of the received data packets and the amount of propagation loss incurred; and
choosing a frequency and a receiver corresponding to a highest received power or lowest propagation loss for further communications.

7. The method of claim 6, wherein a successful ping and reply handshake identifies a neighboring communication node which gets added to a network list along with corresponding frequency.

8. The method of claim 6, wherein when a receiving node does not reply to the request of the transmit node, the transmit node decides to task one of the remaining receiving nodes to interrogate a non-responsive node and act as an intermediate node during future communications.

9. The method of claim 6, wherein each node has its own ID and its messages can be distinguished when nodes operate on the same frequency.

10. The method of claim 6, wherein nodes on the network list share corresponding best frequencies and a single node calculates a best joint frequency and transmits to other nodes.

11. The method of claim 1, further comprising performing a frequency auto-configuration approach by the plurality of nodes within the enclosed volume to discover on which frequencies corresponding neighboring nodes can communicate.

12. The method of claim 1, further comprising a node optionally switching between listening and sending modes to discover additional neighbor communication links.

13. A system for enabling communications within an enclosed volume, comprising:
a plurality of nodes within the enclosed volume that communicate at one or more eigenmode resonant frequencies of the enclosed volume, wherein the enclosed volume is a resonator, and wherein one or more optimum frequencies of communication among the plurality of nodes is selected from the eigenmode resonant frequencies.
